(19) United States
(12) Patent Application Publication
(10) Pub. No.: US 2023/0227215 A1
(43) Pub. Date: Jul. 20, 2023

(54) A LID

(71) Applicant: HANPAK LIMITED, Laois (IE)

(72) Inventor: Wei LU, Dublin (IE)

(21) Appl. No.: 18/010,482

(22) PCT Filed: Jun. 15, 2021
(86) PCT No.: PCT/EP2021/066163

§ 371 Date: Dec. 15, 2022

(30) Foreign Application Priority Data
Jun. 15, 2020 (IE) S2020/0125

(51) Int. Cl. B65D 43/02

(52) U.S. Cl. CPC B65D 43/022; B65D 2543/00398; B65D 2543/00046; B65D 2543/00092; B65D 2543/00231; B65D 2543/00268; B65D 2543/00296; B65D 2543/0049; B65D 2543/00546

(57) ABSTRACT

A rimless lid (10, 97, 99) for a container, the rimless lid comprising: a cover member having an outer side (1) and an inner side (3) and a peripheral edge (5); and a reinforcing arrangement comprising one or more reinforcing members (30, 140, 530, 540, 630, 640) located at the inner side (3) of the cover member; wherein at least one of the peripheral edge (5) of the cover member or the one or more reinforcing members (30, 140, 530, 540, 630, 640) is/are configured to frictionally engage an internal wall of the container when the lid is mounted thereto.

### FIELD OF THE INVENTION

The present invention relates to a lid for a container for contents of a viscous nature such as, for example, soup, porridge, noodles or for solid foods or for hot and/or cold drinks, e.g. coffee, tea, soda, beer, etc., but not limited thereto.

### BACKGROUND OF THE INVENTION

Disposable lids for disposable and re-usable containers, such as food or beverage cups, are well known. Some such lids have drinking apertures, some are fully closed. Many lids for food or beverage containers are made of plastic. Plastic disposable lids are not environmentally friendly for many reasons. Paper or cardboard lids are biodegradable and are therefore more environmentally friendly than plastic lids. Paper lids are typically known to be used on single use soup cups but not on single use beverage cups. Recently paper lids began to be used on single use beverage cups. Generally existing paper lids are difficult to make and bulky to store. They also often fit either too loosely or too tightly on the container. In the former case, the container is unsafe to handle as the lid can easily fall off. In the latter case, the lid is difficult to remove and the presence of suction caused by air-tightness makes the contents prone to splash out forcefully when the lid is removed. The small vent holes provided in such lids are typically insufficient to mitigate suction.

The present invention provides an improved lid for a food or beverage container which is environmentally friendly, easy and more safe to use, fits more easily and securely to the container, facilitates both delivery and ‘on the go’ consumer use, provides an enhanced consumer experience, stacks efficiently thereby reducing storage space requirement and is relatively easy and inexpensive to manufacture compared with prior art lids.

### SUMMARY OF THE INVENTION

Accordingly, in one embodiment of the invention there is provided a rimless lid for a container, the rimless lid comprising:
a cover member having an outer side and an inner side and a peripheral edge; and
a reinforcing arrangement comprising one or more reinforcing members located at the inner side of the cover member;
   wherein at least one of the peripheral edge of the cover member or the one or more reinforcing members is/are configured to frictionally engage an internal wall of the container when the lid is mounted thereto.

Optionally, one or more reinforcing members depend from the inner side of the cover member.

Optionally, at least one reinforcing member is configured to frictionally engage an internal wall of the container.

Optionally, the peripheral edge of the cover member is configured to frictionally engage an internal wall of the container.

Optionally, the peripheral edge of the cover member and at least one reinforcing member are configured to frictionally engage an internal wall of the container.

Optionally, the or each reinforcing member depending from the cover member makes frictional contact with the inner wall of the container at at least two discrete locations on the inner wall of the container.

Optionally, there is provided a reinforcing member comprising a reinforcing panel that is connected to the one or more reinforcing members that depend from the inner side of the cover member, the reinforcing panel being arranged spaced apart from and substantially parallel with said cover member.

Optionally, the reinforcing panel is a shield panel.

Optionally, the reinforcing panel comprises a peripheral edge that is configured to frictionally engage the internal wall of the container.

Optionally, the peripheral edge of the cover member is reinforced, for example by means of a thickened region or peripheral band.

Optionally, the peripheral edge of the reinforcing panel member is reinforced, for example, by means of a thickened region or peripheral band.

Advantageously, rimless lids in accordance with the invention are configured so that mutual interlocking engagement with a container occurs on the interior of said container only. Accordingly mutual interlocking engagement may occur between interior of the container and any one or more of the reinforcing members and/or between the peripheral edge of the cover member.

Thus the rimless lid structure is capable of fitting substantially inside a container with the lid cover member being substantially level with the rim of the container when the lid is mounted thereto. The rimless lid structure securely attaches to the container by the frictional engagement of the cover member and/or reinforcing member or members with the inner wall of the container. This eliminates the requirement for a curved rim or upstanding and/or depending skirt around the outer edge of the lid for clips or fitting over the opening/rim of the container. For aesthetic and hygiene reasons the outer side of the lid cover member may project or span across the top of the opening of the container.

Optionally, the cover member is substantially planar. As a consequence, if the lid is provided with a drinking aperture in the cover member, less tilting of the container is required during drinking than if would otherwise be the case if the lid surface is raised above or recessed below the rim of the container.

Preferably, the rimless lid is made from a biodegradable, recyclable or compostable material, such as paper, paperboard, cardboard, vegetable starch or other suitable plant-based material. The application of this invention may extend beyond paper lids, including to lids made from plastic and other materials. Thus, alternatively, e.g. the lid may be made from PET plastic for use with recyclable PET plastic cups. Alternatively, other materials may be used.

The rimless lid is suitable for use with a container for contents (1) of a viscous nature such as, for example, soup, porridge, noodles, (2) for solid foods such as fries or popcorn, and (3) for hot and/or cold drinks, e.g. coffee, tea, soda, beer, etc., but is not limited thereto.

The terminal edges of the one or more reinforcing members (including the reinforcing panel) are preferably arranged so as to fit snugly against and/or deform the wall of the container (in the case where the material of the container is capable of being deformed by the one or more reinforcing members) thereby holding the rimless lid securely in place and imparting rigidity on the rimless lid/container assembly. The one or more reinforcing members may also provide structural support and rigidity to the lid itself. The one or more reinforcing members may also provide structural support and rigidity to the container.

In one arrangement, at least one reinforcing member, preferably a depending reinforcing member, extends across the inner side of the cover member. The at least one reinforcing member preferably has a pair of opposite container engaging portions located at opposite peripheral locations on the inner side of the cover member, such that when the rimless lid is placed over an open top of the container, the at least one depending reinforcing member enters the container and the container engaging portions frictionally engage the inner wall of the container at opposing peripheral locations on the wall of the container. In this manner, the rimless lid may be secured to the container.

Optionally, the or each reinforcing member makes frictional contact with the inner wall of the container at at least two discrete locations on the inner wall of the container.

In an optional arrangement, at least two such reinforcing members are provided, each reinforcing member being provided across the inner side of the cover member. The at least two reinforcing members may cross or intersect each other.

In a further optional arrangement, the at least two reinforcing members are non-intersecting. Optionally, non-intersecting reinforcing members are substantially or broadly parallel to each other.

Multiple other alternative arrangements to achieve the level of friction required are also possible and envisaged.

In an optional arrangement, the at least one reinforcing member is configured to engage the inner wall of the container at multiple discrete locations. For example, a reinforcing member may comprise three portions, arranged for example in a ‘Z’ shaped configuration when viewed in plan view, and configured to engage the inner wall of the container at four discrete locations. It will be appreciated that other alternative arrangements are possible in order to provide the required number of discrete contact positions to achieve a desired degree of frictional engagement of the rimless lid to a container.

In the arrangement where the reinforcing members cross or intersect each other, suitable cooperating slots or other openings can be made in the respective reinforcing members so that said reinforcing members can cross each other upon assembly. The reinforcing members can structurally reinforce and strengthen both each other and the overall rimless lid structure by crossing each other and interlocking.

Optionally, the one or more reinforcing members of the rimless lid may comprise one or more ribs.

Optionally, the one or more reinforcing members may be integrally for formed with the cover member.

Optionally, the cover member of the rimless lid may be formed from a piece of planar sheet material, e.g. card paper, and folded along pre-defined lines to form the or each reinforcing member as a rib.

Optionally, for example where the rimless lid is formed by moulding, a rib or ribs can be integrally moulded with the cover member.

Alternatively, or in addition, a reinforcing members can be formed as a second rib from either the cover member or from another piece of planar sheet material and attached (e.g. by glue, welding or another suitable method) to the inner side of the lid.

Optionally, the one or more reinforcing members are movable between expanded and collapsed states. In the expanded state, the one or more reinforcing members project proud of the inner side of the cover member so the lid can be used to close the container. When the one or more reinforcing members collapse, the one or more reinforcing members move closer to the cover member, preferably, flush with the cover member. Such an arrangement allows a plurality of lids to be stacked and stored whilst minimising storage space required to store the lids.

In the optional arrangement where the reinforcing members cross each other, the cooperating openings in the first and second reinforcing members can be configured so that the first and second reinforcing members cross each other upon assembly and to permit movement of the first and second reinforcing members relative to each other and articulation relative to the lid during movement between the expanded and collapsed states. In one arrangement, each of the first reinforcing member and the second reinforcing member has fold or hinge lines close to the lid. When the first and second reinforcing members are moved from the expanded state into the collapsed state, for example, by the user applying external force on the first and second reinforcing members, the first and second reinforcing members are allowed to articulate about their respective hinge lines relative to the lid and thereby move closer to the lid. In order to bring the first and second reinforcing members into the expanded state, the first and second reinforcing members are pivoted, e.g. by the user applying external force, in the opposite direction, i.e. away from the lid, about their respective hinge lines until the first and second reinforcing members project proud of the inner side of the lid. Preferably, interaction between the reinforcing members allows them to click firmly into, and remain fixedly in, position by means of, for example, suitable cooperating slots to hold them firmly in the expanded position.

In the optional arrangements where there is a single reinforcing member or where the reinforcing members do not cross over each other, the reinforcing member(s) may be foldable or collapsible flat against the lid and movable between said folded/collapsed state to a deployed or expanded state.

Optionally, when in the expanded state, reinforcing member(s) may be secured in the expanded position a fastening arrangement.

Suitable fastening arrangements can be in a number of possible forms.

Optionally, in one arrangement, the fastening arrangement comprises a movable tab or clip arrangement where the movable tab or clip is a cut out portion of the reinforcing member that is pushed from the closed to the open position and creates a circa 90 degree angle along a section of the reinforcing member that prevents the reinforcing member collapsing and the lid moving closer together and folding back into the collapsed/folded position. Once it is pushed into the open, fixed position the reverse movement of a fastening tab or clip can be prevented by forming a detent, for example a raised line or crease in the lid at the preferred retaining position configured to prevent the movable tab or clip from moving back to its original position.

The container may have a rim that is circular, round-cornered rectangular or other shape. The rimless lid may be of a shape generally suitable to the shape of the container. An advantageous arrangement may be that the shape or the rim of the container and the shape of the rimless lid are slightly different to increase friction between the container and the rimless lid and make the closing more secure. For example, where the container has a circular rim the rimless lid may be oval. In this instance when the rimless lid closes the container, the at least one reinforcing member frictionally engages the internal wall of the container and causes it to deform (in the case where the material of the container is capable of being deformed by the at least one reinforcing member) and to assume the oval shape of the rimless lid thereby making the contact between the container and the rimless lid stronger, making the closing more secure, increasing rigidity of the rimless lid/container assembly and increasing the structural strength and solidness of the container for holding, etc.

As noted above, in examples, the rimless lid may comprise a reinforcing member in the form of a panel provided at the inner side of the cover member and spaced apart therefrom.

Optionally, the reinforcing panel is spaced from the inner side of the cover member by the one or more reinforcing members.

Optionally, the reinforcing panel is a shield panel.

It will be understood that in the present description, the words ‘reinforcing panel’ and ‘shield panel’ are synonymous and interchangeable.

The reinforcing panel may be sized and shaped so that its peripheral edge fits snugly against the internal wall of the container. This imparts additional rigidity onto the rimless lid/container assembly and makes the container safer to handle. For example, the reinforcing panel may be shaped to match closely the shape in plane of the wall of the container at a level where the reinforcing panel is located inside the container when the rimless lid is placed on the container. Where the rim of the container is circular and the rimless lid is oval shaped, the reinforcing panel may also be oval shaped. In the latter case, when the rimless lid closes the container, the peripheral edge of the reinforcing panel engages and causes the wall of the container to deform (in the case where the material of the container is capable of being deformed by the shield panel) and to assume the oval shape of the reinforcing panel thereby increasing the rigidity of the lid/container assembly. Simultaneously with imparting rigidity onto the rimless lid/container assembly, the snug fit of the reinforcing panel sealingly secures the rimless lid to the container so that the lid is held securely on the beverage container whilst preventing leaks. Additionally, the reinforcing panel keeps the contents of the container away from the inner side of the cover member of the rimless lid and from the rim of the container.

Optionally, the shield panel is planar. The shield panel may be formed from a single sheet material or from a moulded material.

The shield panel may comprise a strengthened, raised or thickened area around its circumference or peripheral edge (either entirely or in a number of locations). This raised area can be created by a number of methods, for example a curl can be applied to the circumference of the shield panel (similar to the curl used around the rim of disposable drinks cups). Alternatively, the circumference can be thickened or strengthened by another method or a separate largely circular band can be fixed to the circumference of the shield panel by adhesive, welding or other method. In the case of a moulded shield panel the shape of the mould can be adjusted to provide for this reinforced area or areas around the circumference of the shield panel.

The primary purpose of the raised or thickened area or areas around the circumference of the shield panel is to increase the structural strength of the shield panel and to increase the level of friction between the shield panel and the inside wall of the container in use, thereby making the closure friction between the lid and the container more solid and secure.

The shield panel may include suitable reinforcement across the planar area to give the shield panel additional structural strength. Such reinforcement can be achieved in several ways, for example by the addition of one or multiple reinforcing bands or ribs.

As noted above, the shield panel may be attached to the inner side of the lid cover member via the one or more reinforcing members. In this way the one or more reinforcing members of the various optional examples act as connectors connecting the cover member and the shield panel, and as spacers which keep the shield panel spaced from the cover member.

In examples where the reinforcing member or members are collapsible, the one or more reinforcing members keep the cover member and the shield panel spaced from each other when in the expanded state, so that the combined structure of cover member, reinforcing member(s) and shield panel close the beverage container. When the one or more reinforcing members are in the collapsed/folded state, the cover member and the shield panel are moved together so as to reduce or eliminate the space between said cover member and shield panel. Such a collapsed/folded arrangement allows a plurality of rimless lids to be stacked and stored in a flat pack configuration whilst minimising storage space required to store the lids.

The expanded state between the lid and the shield panel may be securely fixed and held in position by a fastening arrangement. This fastening arrangement can be released by the user, allowing the lid and shield panel to revert to the collapsed/folded position.

The fastening arrangement can take a number of forms, depending upon the configuration of the reinforcing members.

In the configuration where the reinforcing members do not cross over each other but are either fully or partly parallel or of a ‘Z’ type configuration the fastening arrangement may comprise a movable tab or clip type arrangement where the tabs or clips are pushed from the closed to the open position and create a circa 90 degree angle along a section of the reinforcing member, preferably on each reinforcing member, that prevents the reinforcing member collapsing and the lid and shield panel moving closer together and folding back into the collapsed/folded/flat-pack position.

Once it is pushed into the open, fixed position the reverse movement of a fastening tab or clip can be prevented by detent, for example a raised line or crease at the preferred retaining position in the cover member and/or in the shield panel, that is configured to prevent the fastening tab or clip from moving back to its original position.

In the configuration whereby the reinforcing members cross over or intersect each other (optionally at a 90 degree angle to each other) the fastening arrangement may be to be a hinge like structure.

The one or more reinforcing members may be in the form of first and second ribs as described above. In this arrangement, a first rib is preferably permanently attached to or formed with one of both of the cover member and the shield panel. The second rib is preferably permanently attached to or formed with one of or both of the cover member and the shield panel and releasably attached to the other of the cover member and the shield panel. The second rib may be releasably attached to the cover member and the shield panel by a suitable fastening arrangement. The fastening arrangement prevents the first and second ribs from collapsing. The fastening arrangement may comprise, for example, a tab provided on the second rib and a slot formed in the lid or the shield panel, whichever the second rib is releasably attached to. In the expanded state of the first and second ribs, the tab is engaged in the slot and the second rib is prevented from articulating relative to the cover member or the shield panel, whichever the second rib is attached to. In this arrangement, the first rib has a pair of first hinge lines, one close to the cover member, the other close to the shield panel and the second rib has a second hinge line close to the cover member or the shield panel, whichever the second rib is attached to. When the first and second ribs are moved from the expanded state into the collapsed state, for example, by the user applying external force on the cover member and the shield panel so as to push the cover panel and the shield panel towards each other, the fastening arrangement de-couples (or, in a specific arrangement, the tab of the second rib disengages from the slot) and the second rib is disengaged from the cover member or the shield panel, whichever the second rib is fastened to via the fastening arrangement. At the same time, the first rib is allowed to articulate about the first hinge lines relative to the cover member and the shield panel and the second rib is allowed to articulate about the second hinge line relative to the cover member or the shield panel, whichever the second rib is attached to. As both the first rib and the second rib articulate about their respective first and second hinge lines, the cover member and the shield panel move close together and the space between the cover member and the shield panel is reduced or eliminated. In order to return the first and second ribs into the expanded state, the user applies a force to the cover member and the shield panel directed to spreading the cover member and the shield panel apart and the above described steps are repeated in reverse order. At the end of the return of the second rib into the expanded state, the fastening arrangement engages (or, in a specific arrangement, the tab of the second rib engages the slot) and the second rib engages the cover member or the shield panel, whichever the second rib is fastened to via the fastening arrangement, so as to secure the second rib and the entire assembly in the expanded state. Alternatively, the ribs may interlock in a broadly similar manner.

The shield panel (i.e. reinforcing panel) may contain venting holes or cut-outs of an appropriate size and location to allow the escape of pressure built up from steam or gas generated by hot contents or contents containing gas.

The secure fixing and grip of the lid to the container may be enhanced by the forming of a raised line or crease on the inner wall of the container which circumvents the entire or part of the wall of the container just below the location where the shield panel makes contact with the inner wall of the container. The shield panel effectively clips below this raised line or crease and helps to secure the shield panel fixedly in position at its optimal retaining position and helps prevent the shield panel from loosening its contact with the container.

An aperture may be formed in the cover member to allow the drinking, pouring of liquids or the picking of solid foods from the container without the need to remove the lid from the container.

An aperture used for drinking may be curved and shaped to allow the lips of a consumer to make full, direct and unobstructed contact with the rim of the beverage container so that a consumer may drink directly from the container, rather than through an enclosed aperture in the lid. This feature considerably enhances the drinking experience for the consumer.

In one arrangement, the rimless lid may comprise a flap formed in the cover member and initially blocking the aperture. The cover member may further comprise a weakened area, provided by, for example, serrations, perforations or thinning of the lid material, the weakened area defining the flap and allowing the flap to be torn off in order to open the aperture, while until opened, the lid, together with the flap, provide a fully sealed closure.

In a second arrangement the flap may be repeatedly opened and securely closed in intervals between consuming, to prevent splashing or spilling from the container. The flap may be constructed, in conjunction with the lid, to remain fixed in either the open position or the closed position for the convenience of the user.

In conjunction with the provision of a drinking aperture, a flow deflector arrangement may be provided at the inner side of the cover member adjacent to the drinking aperture. The flow deflector arrangement is preferably configured to prevent liquid contained in the container, especially watery liquid prone to splashing, from splashing directly upwardly through the drinking aperture when the container is in a generally upright orientation. The flow deflector arrangement is further preferably configured to allow the liquid to approach the drinking aperture sideways or indirectly so that the liquid loses much of its energy/momentum by the time it reaches the drinking aperture, thereby reducing the possibility and intensity of unexpected spills or splashes when drinking or pouring from the container. In one arrangement, the flow deflector arrangement comprises a portion arranged substantially in front of the drinking aperture to deflect splashing liquid or to prevent it from flowing directly into the drinking aperture.

In one arrangement, the shield panel described above is adapted to serve as the flow deflector arrangement.

For this purpose, in one possible arrangement, the shield panel may have one or more cut-outs in the proximity of the drinking aperture so as to define a flow opening. These cut-outs may, together with the inner side of the container, define a flow opening.

During drinking, when the container is tilted, liquid will flow through the flow opening and towards the drinking aperture. When the container is in the upright position, the shield panel prevents splashes caused by shaking the container from reaching the drinking aperture.

In a second arrangement, the flow opening may comprise cut-outs located fully within the perimeter of the shield panel but sufficiently adjacent to the inner side of the cover member as to allow easy flow from the container through the cut-outs when the container is tilted.

An intermediate well that acts as a flow deflector to prevent direct splashing out of the container can be created between the shield panel and a second panel that sits flat against and above the shield panel before the lid is fitted into the cup. The second panel is shaped to overlay the shield panel in the area directly below the drinking aperture and is not fixed or glued to the shield panel at this location. The peripheral edge of the second panel extends marginally further than the peripheral edge of the shield panel. As a consequence, when the lid is fitted into the container the contact created with the inner wall of the container causes the second panel to separate from the shield panel and create an intermediate well or substantially enclosed space. One or more cut-outs in the shield panel will allow liquid to flow from the container into the intermediate well when the container is tilted. One or more cut-outs in the second panel will allow liquid to flow out of the intermediate well for drinking when the container is tilted. The cut-out or cut-outs in the shield panel and the second panel are located distant and not opposite each other so that liquid cannot splash directly into, through and out of the intermediate well in a direct line of movement. This structure facilitates drinking or pouring from the container in a smooth movement and flow of liquid, but prevents splashing.

Preferably, the container is a cup. The shape of the cup will vary depending upon the nature of the contents, for example, whether the contents are a beverage to be drank directly or poured from the container or a viscous food such as soup to be spooned or poured out of the container or a solid food to be picked or tipped out of the container.

The rimless lid described herein has application for both single use disposable lids and reusable lids.

It will be appreciated that features of the embodiments described above may be combined, where appropriate, with the other embodiments and/or indeed form novel and inventive aspects in their own right.

### DETAILED DESCRIPTION OF THE INVENTION

Embodiments of the present invention will now be described, by way of example only, with reference to the accompanying drawings in which:

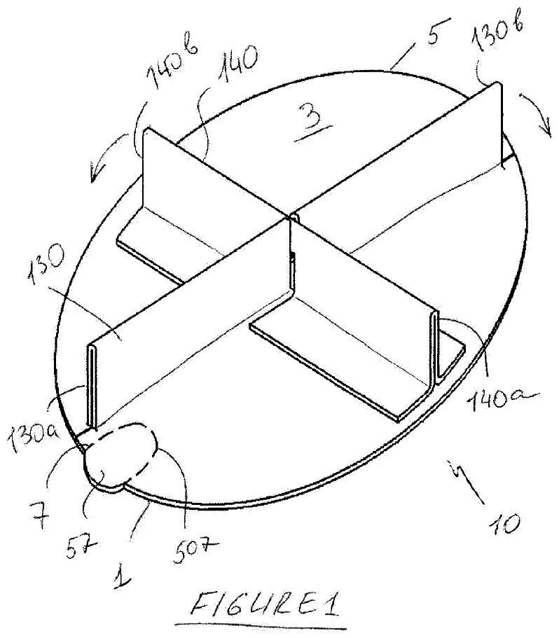

FIG. 1 is a schematic perspective view of a rimless lid in accordance with the invention;

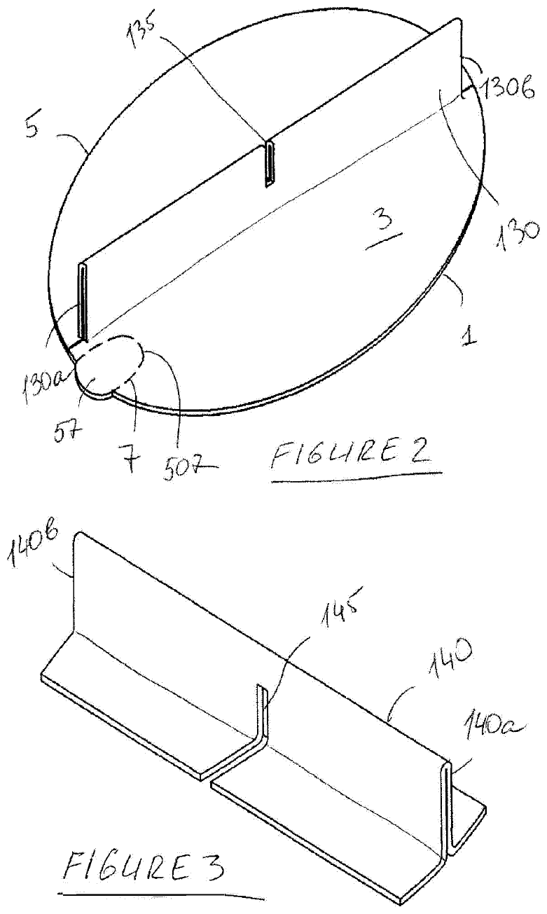

FIG. 2 is schematic perspective view of a rimless lid part of FIG. 1;

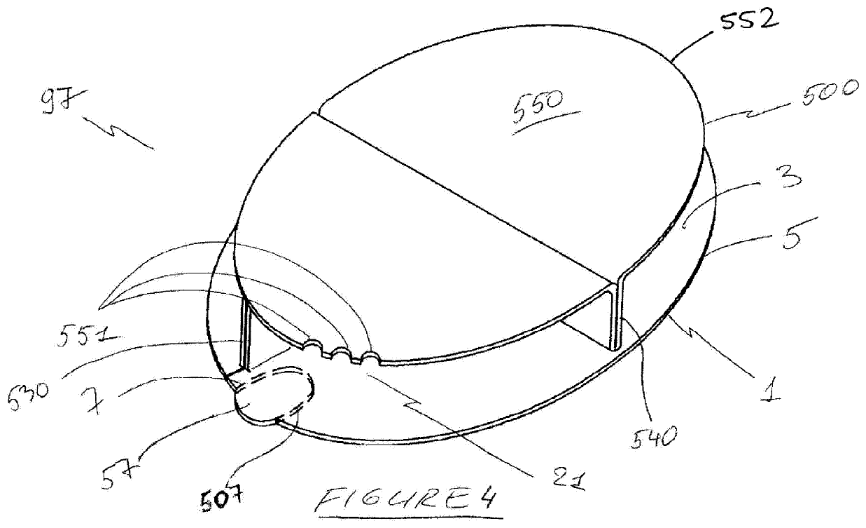

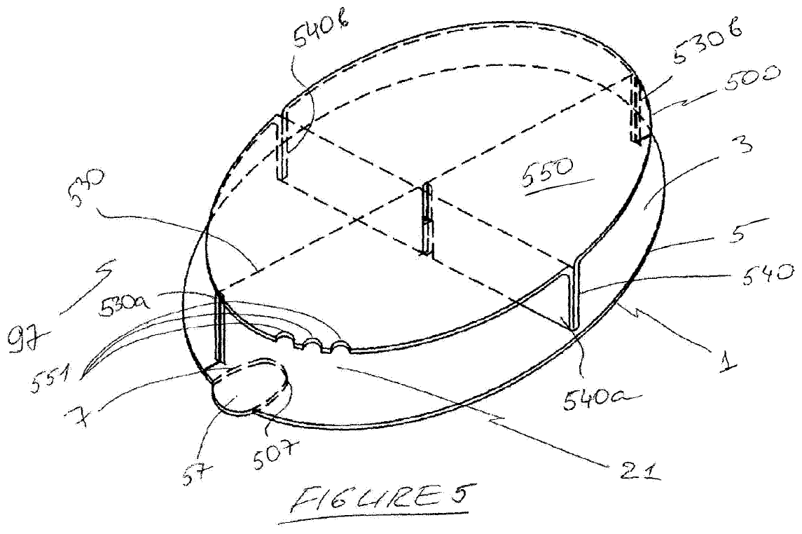

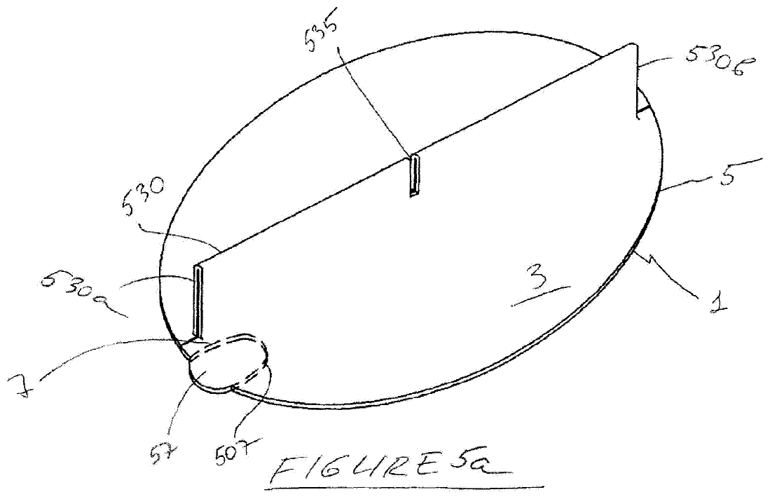

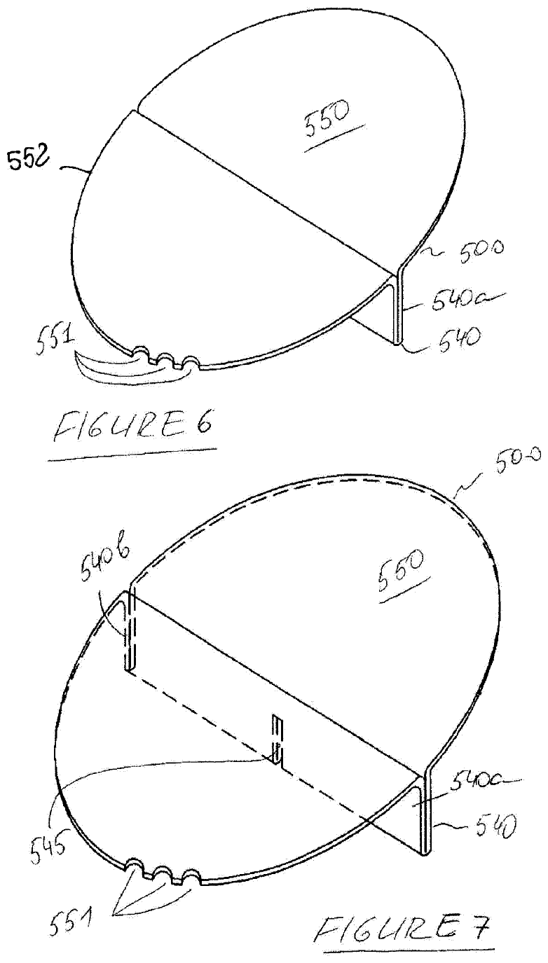

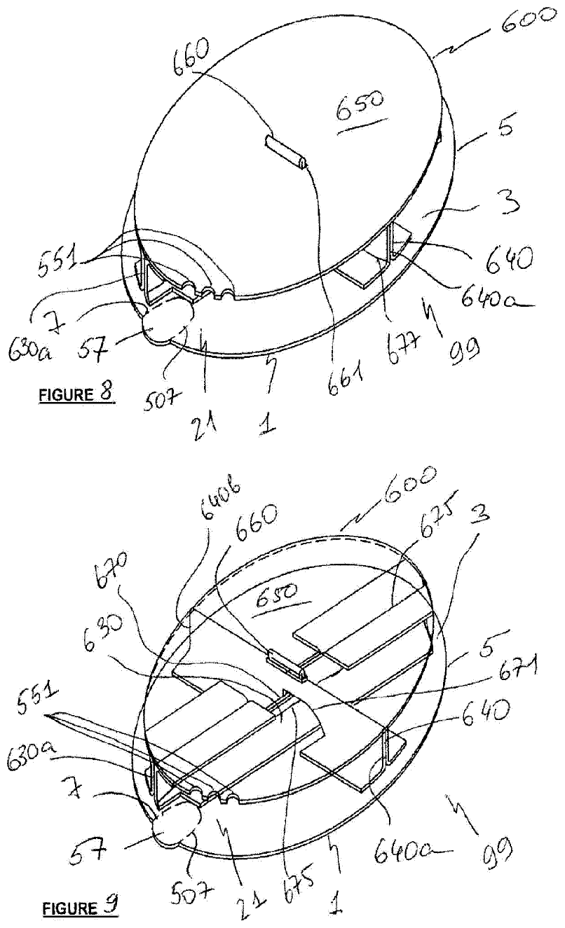

FIG. 3 is schematic perspective view of a reinforcing member of the rimless lid of FIG. 1;

FIG. 4 is schematic perspective view of a variation of a rimless lid in accordance with the invention;

FIG. 5 is a transparent view of the rimless lid of FIG. 4;

FIG. 5a is a schematic perspective view of a rimless lid part of FIG. 4;

FIG. 6 is a schematic perspective view of a flow deflector part of FIG. 4;

FIG. 7 is a transparent view of the flow deflector of FIG. 6;

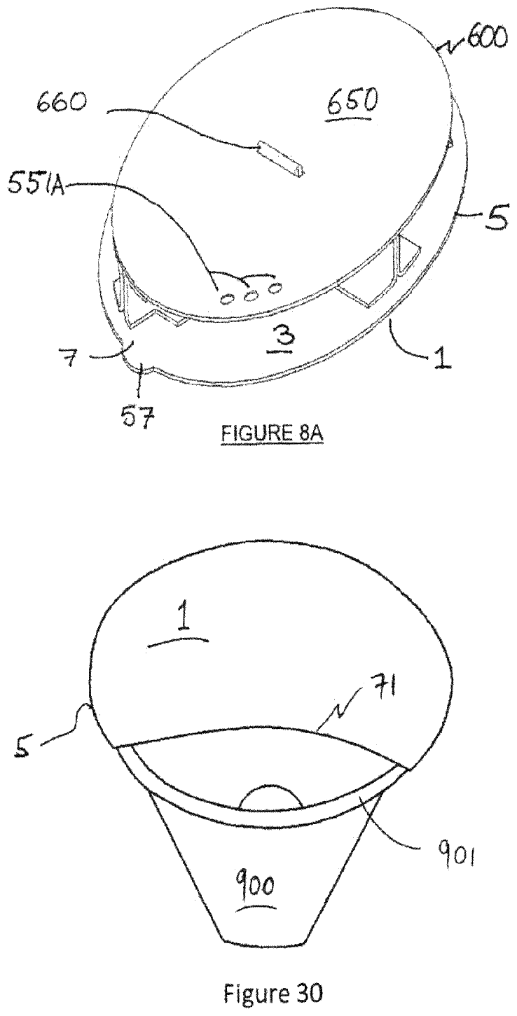

FIG. 8 is schematic perspective view of a modification of a rimless lid of FIG. 4;

FIG. 9 is a transparent view of the rimless lid of FIG. 8;

FIGS. 10 and 11 are schematic perspective views of reinforcing members of the rimless lid of FIGS. 8 and 9 in an expanded state;

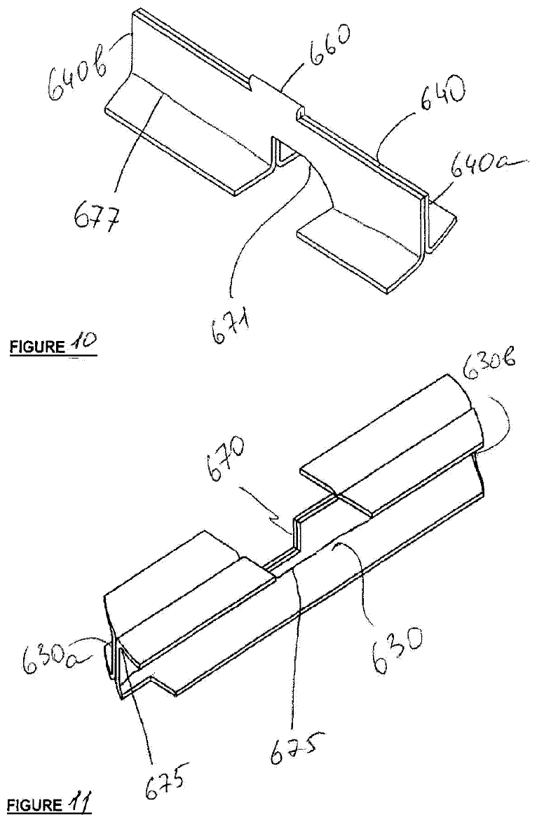

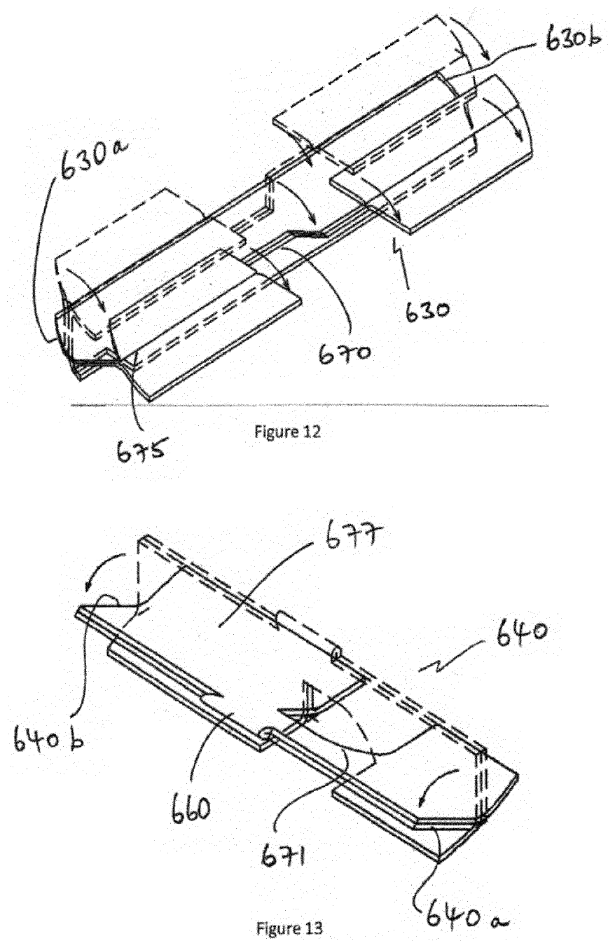

FIGS. 12, 13 and 14 are schematic perspective views of the reinforcing ribs of FIGS. 10 and 11 in a collapsed state;

FIG. 15 is a transparent view of the rimless lid of FIG. 8 in a collapsed state;

FIG. 16 is a non-transparent view of the rimless lid of FIG. 15;

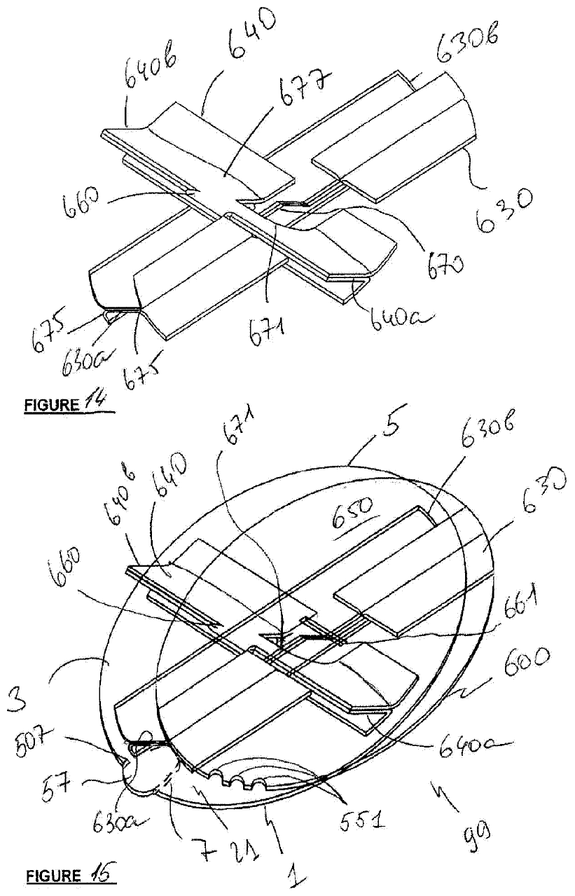

FIG. 17 is a schematic perspective view of a rimless lid part of the lid of FIGS. 8, 15 and 16;

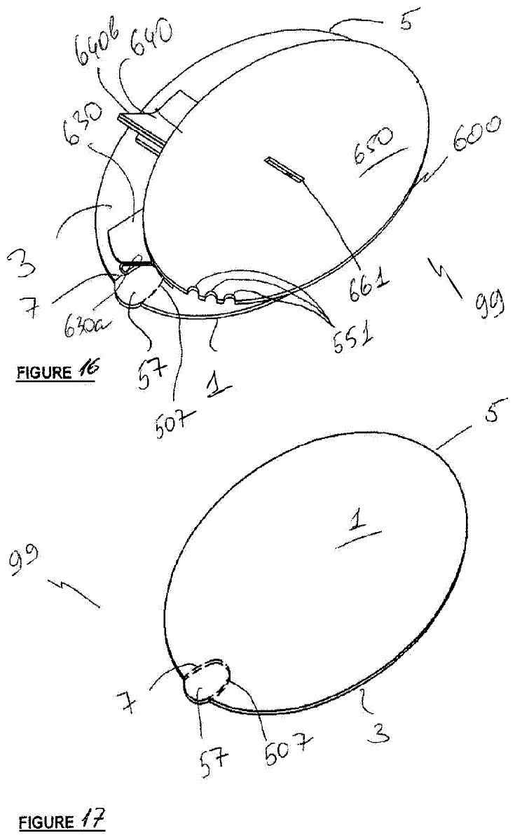

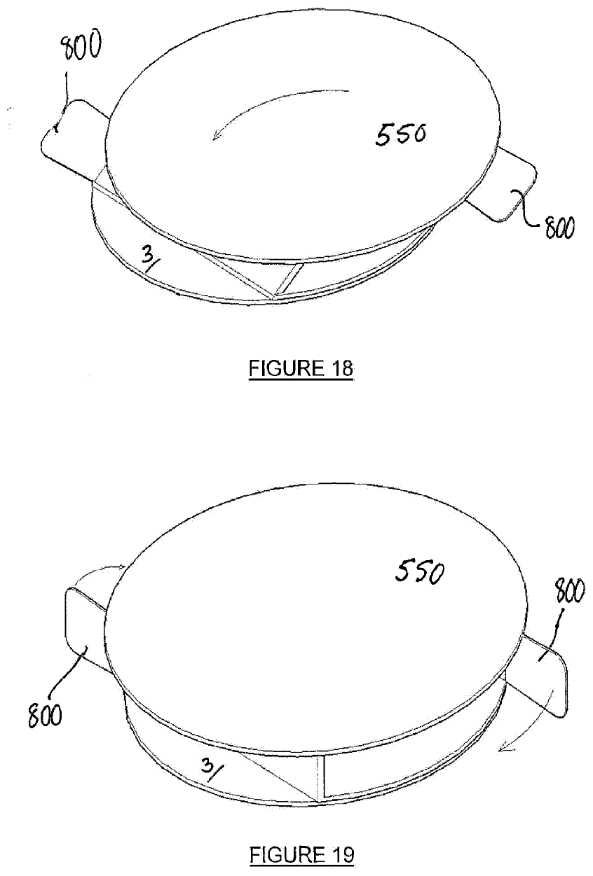

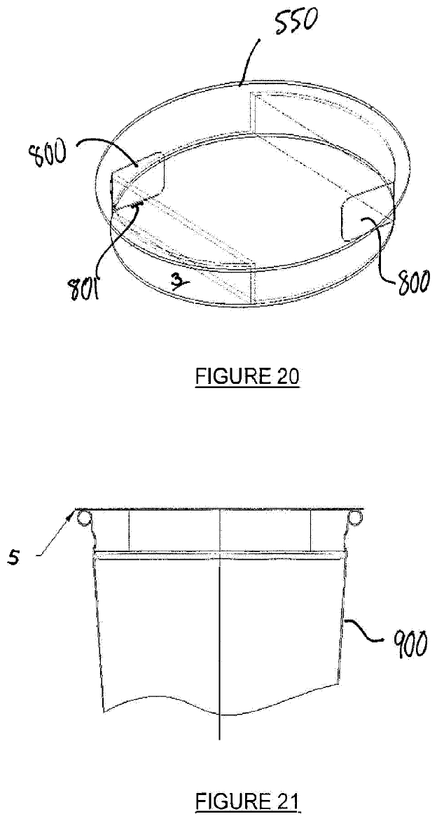

FIG. 18 is a schematic view of a rimless lid in a collapsed state; FIGS. 19 and 20 are schematic views of the rimless lid of FIG. 18 in an expanded state;

FIGS. 21 to 27 are a schematic view of rimless lids located on containers;

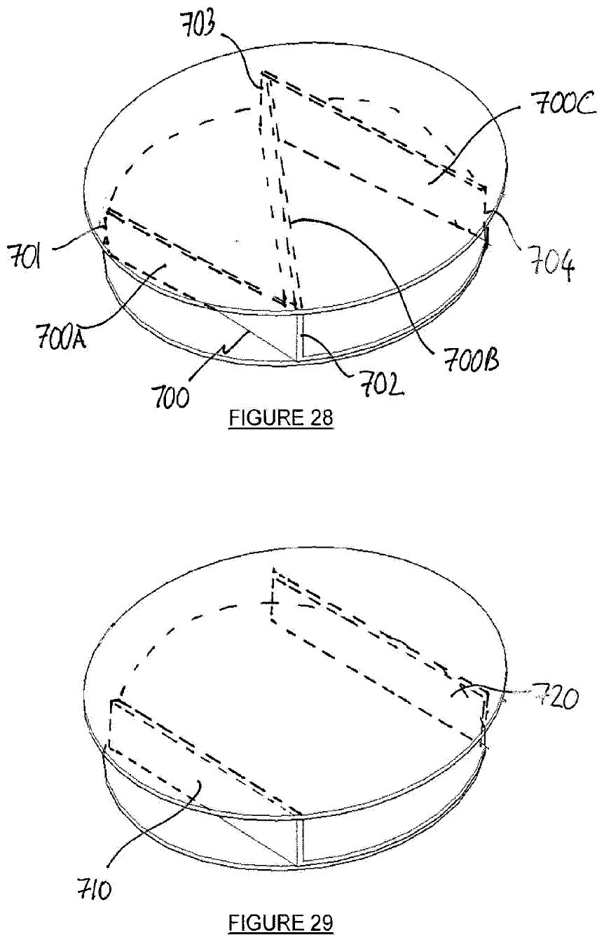

FIGS. 28 and 29 are a schematic perspective views of reinforcing member arrangements of a rimless lid; and

FIG. 30 is a schematic illustration of a variation of a drinking aperture formed in a rimless lid in accordance with the invention.

In the drawings, a rimless lid in accordance with the invention is indicated generally using reference numerals 10, 97 and 99. Initially, common features of the rimless lid 10, 97, 99 will be described. Common features have been indicated using the same reference numeral for brevity. The rimless lid 10, 97, 99 comprises a cover member having an outer side 1, an inner side 3 and a peripheral edge 5. The rimless lid 10, 97, 99 is adapted to be fastened to an internal wall of a container 900 (see FIGS. 21-27), about an open top thereof, as will be described below. The rimless lid 97, 99 is adapted to be sealingly fastened to the internal wall of the container, as will be described below. The rimless lid 10, 97, 99 is preferably made from a recyclable, biodegradable or compostable material, such as paper, paperboard, cardboard, vegetable starch or other suitable plant-based material.

A least one reinforcing member 130, 140, 530, 540, 630, 640 are provided on the inner side 3 of the cover member of the rimless lid 10, 97, 99. The reinforcing members depend from the inner side of the cover portion. The depending reinforcing members 130, 140, 530, 540, 630, 640 may be referred to as ribs. Reinforcing members, or ribs, 130, 140, 530, 540, 630, 640 are configured to frictionally engage an internal wall of the container as will be described below.

The rimless lid 10, 97, 99 is preferably suitable for a container for viscous fluids, such as, for example, soup. However, it will be appreciated that the rimless lid can be used with a container for solid foods as well as with a container for hot and/or cold drinks, e.g. coffee, tea, soda, beer, etc., but not limited thereto.

The reinforcing members/ribs 130, 140, 530, 540, 630, 640 are adapted to fit snugly against and/or deform the wall of the container (in the case where the material of the container is capable of being deformed by the ribs 130, 140, 530, 540, 630, 640). This holds the rimless lid 10, 97, 99 securely in place and imparts rigidity on the rimless lid 10, 97, 99/container assembly. The ribs 130, 140, 530, 540, 630, 640 also provide structural support and rigidity to the rimless lid 10, 97, 99 itself.

As shown in FIGS. 1, 5, 9, and 15 each rib 130, 140, 530, 540, 630, 640 extends across the inner side 3 of the cover member of the respective lid 10, 97, 99. Each rimless lid 10, 97, 99 has at least one, but preferably a pair of respective ribs 130, 140; 530, 540; and 630, 640. The ribs 130, 140; 530, 540; and 630, 640 of each pair may cross or intersect each other. Cooperating slots 135, 145; 535, 545 and cut outs 670, 671 are made in the respective ribs 130, 140; 530, 540; and 630, 640 so that the ribs 130, 140; 530, 540; and 630, 640 can cross each other upon assembly. Alternatively, in examples, the ribs may be non-intersecting.

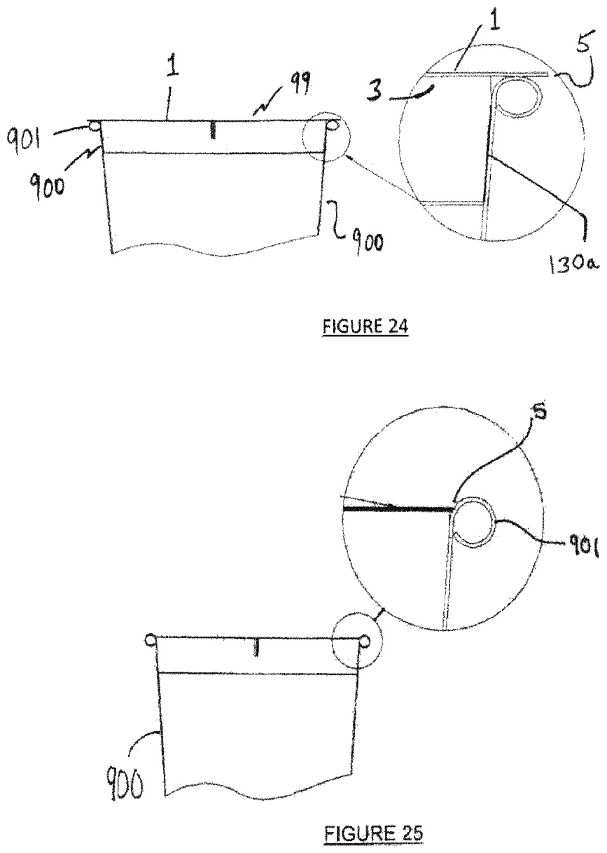

As shown in detail in FIG. 24, each reinforcing member 130, 140, 530, 540, 630, 640 has a pair of opposite container engaging portions 130a, 130b, 140a, 140b, 530a, 530b, 540a, 540b, 630a, 630b, 640a, 640b located at opposite peripheral locations on the inner side 3 of the rimless lid 10, 97, 99. When the cover member of the rimless lid 10, 97, 99 is placed over an open top of the container, the reinforcing member 130, 140, 530, 540, 630, 640 enters the container and the container engaging portions 130a, 130b, 140a, 140b, 530a, 530b, 540a, 540b, 630a, 630b, 640a, 640b frictionally engage the internal wall of the container. In this manner, the rimless lid 10, 97, 99 is secured to the container.

In the examples of FIGS. 1 to 7, the rimless lid 10, 97 is formed from a piece of planar sheet material, e.g. card paper, and folded along pre-defined lines to form first ribs 130, 530. In the examples of FIGS. 8 to 17, a first rib 630 is formed from a separate piece of planar sheet material and attached (e.g. by glue, welding or another suitable method) to the inner side 3 of the lid 99 cover member.

In the examples shown in FIGS. 1 to 3 and 8 to 17, a second rib 140, 640 is formed from another piece of planar sheet material and attached (e.g. by glue, welding or another suitable method) to the inner side 3 of the cover member of the lid 10, 99. In the example of FIGS. 4 to 7, a second rib 540 is formed as part of a shield panel 550 reinforcing member (to be described below in more detail). The shield panel 550, like the rimless lid 97, is formed from a piece of planar sheet material and folded along pre-defined lines to form the second rib 540.

In the examples of FIGS. 1 to 3 and 8 to 17, the reinforcing members/ribs 130, 140, 630, 640 are movable between expanded and collapsed states. In the expanded state (see FIGS. 1, 8 and 9), the ribs 130, 140, 630, 640 project proud of the inner side 3 of the cover member of the lid 10, 99 so the lid 10, 99 can be used to close the container. When the ribs 130, 140, 630, 640 collapse (see FIGS. 12 to 16), the ribs 130, 140, 630, 640 move closer to the cover member of the lid 10, 99, preferably, flush with the cover member. Such an arrangement allows a plurality of rimless lids 10, 99 to be stacked and stored whilst minimising storage space required to store the rimless lids 10, 97, 99. The cooperating slots 135, 145 and cut outs 670, 671 in the respective ribs 130, 140, 630, 640 are configured so that the respective the ribs 130, 140, 630, 640 cross each other upon assembly and to permit movement of the ribs 130, 140, 630, 640 relative to each other and articulation relative to the lid 10, 99 cover member during movement between the expanded and collapsed states.

In the examples of FIGS. 1 to 3 and 8 to 17, each rib 130, 140, 630, 640 has a respective hinge line 175, 177, 675, 677 close to the respective cover member. When the ribs 130, 140, 630, 640 are moved from the expanded state into the collapsed state, for example, by the user applying external force on the ribs 130, 140, 630, 640, the ribs 130, 140, 630, 640 are allowed to articulate about their respective hinge lines 175, 177, 675, 677 relative to the cover member, and thereby move closer to said cover member. In order to bring the ribs 130, 140, 630, 640 into the expanded state, the ribs 130, 140, 630, 640 are pivoted, e.g. by the user applying external force, in the opposite direction as shown by way of example in FIG. 18, i.e. away from the rimless lid 10, 99, about their respective hinge lines 175, 177, 675, 677 until the ribs 130, 140, 630, 640 project proud of the inner side 3 of the lid 10, 99.

The cover member of the rimless lid 10, 97, 99 may be generally circular or oval in plane. In the described examples, the rimless lid is oval to make the contact between the container and the rimless lid 10, 97, 99 stronger, although the invention is not limited to this specific shape. An oval rimless lid is particularly useful in closing a container having a circular top. When the rimless lid 10, 97, 99 closes the container, the ribs 130, 140, 530, 540, 630, 640 frictionally engage the internal wall of the container and causes it to deform (in the case where the material of the container is capable of being deformed by the ribs 130, 140, 530, 540, 630, 640) and to assume the oval shape of the lid 10, 97, 99 thereby increasing rigidity of the lid 10, 97, 99/container assembly.

In an optional arrangement as shown by way of example in FIG. 28, the at least one reinforcing member is configured to engage the inner wall of the container at multiple discrete locations. For example, a reinforcing member 700 may comprise three portions 700A, 700B, 700C, arranged for example in a ‘Z’ shaped configuration when viewed in plan view, with its respective end edges and corners 701, 702, 703, 704 each configured to engage the inner wall of a container at a discrete location. It will be appreciated that other alternative arrangements are possible in order to provide the required number of discrete contact positions to achieve a desired degree of frictional engagement of the rimless lid to a container.

In the examples of FIGS. 4 to 17, a reinforcing member in the form of a shield panel 550, 650 is provided at the inner side 3 of the respective lid 97, 99 cover member. The shield panel is connected to one or more reinforcing members that depend from the inner side of the cover member, the reinforcing panel being arranged spaced apart from and substantially parallel with said cover member. The reinforcing panel comprises a peripheral edge that is configured to frictionally engage the internal wall of the container.

The shield panel 550, 650 is sized and shaped so that its peripheral edge fits snugly against the internal wall of the container as shown in FIG. 21. This imparts additional rigidity onto the rimless lid 97, 99/container assembly and makes the container safer to handle. The shield panel 550, 650, may be shaped so that its peripheral edge matches closely the shape in plane of the wall of the container at a level where the shield panel 550, 650 is located inside the container when the rimless lid 97, 99 is placed on the container. In the examples of FIGS. 4 to 17, the shield panel 550, 650 is oval shaped. Thus, when the rimless lid 97, 99 closes the container, the peripheral edge shield panel 550, 650 causes the wall of the container to deform (in the case where the material of the container is capable of being deformed by the shield panel 550, 650) and to assume the oval shape of the shield panel 550, 650 thereby increasing the rigidity of the rimless lid 97, 99/container assembly. Simultaneously with imparting rigidity onto the rimless lid 97, 99/container assembly, the snug fit of the peripheral edge of shield panel 550, 650 sealingly secures the rimless lid 97, 99 to the container so that the lid 97, 99 is held securely on the beverage container whilst preventing leaks. Additionally, the shield panel 550, 650 keeps any splashes which may occur of the contents of the container away from the inner side 3 of the lid 97, 99 and from the rim of the container.

In some modifications, the rimless lid 10, 97, 99 may optionally comprise a drinking aperture 7 in the cover member so that the rimless lid 10, 97, 99 can be used for drinking. As shown in FIGS. 1, 2, 4 to 5a, 8, 9 and 15 to 17, the rimless lid 10, 97, 99 may comprise a flap 57 formed in the cover member and initially blocking the drinking aperture 7. The rimless lid 10, 97, 99 may further comprise a weakened area 507, provided by, for example, perforations or thinning of the lid material. The weakened area defines the flap 57 and allows the flap 57 to be torn off in order to open the drinking aperture 7. Until opened, the cover member of the rimless lid 10, 97, 99, together with the flap 57, provide a fully sealed closure.

As shown by way of example in FIG. 30, a drinking aperture 70 may be formed in a cover member that is curved and/or shaped to allow the lips of a consumer to make full, direct and unobstructed contact with the rim 901 of a beverage container 900 so that a consumer may drink directly from the container, rather than through an enclosed aperture in the lid. Such an aperture 70 may be defined by a segment having a curved or arc-shaped chord 71 that is cut or otherwise removed from the peripheral edge 5 of the rimless lid cover member. Such an aperture 70, which exposes a relatively long portion of the container's rim 901 considerably enhances the drinking experience for the consumer.

In the variation where a drinking aperture 7 is provided, a flow deflector arrangement 500, 600 is provided at the inner side 3 of the lid 97, 99 cover member adjacent to the drinking aperture 7. The flow deflector arrangement 500, 600 is configured to prevent liquid contained in the container, especially watery liquid prone to splashing, from splashing directly upwardly through the drinking aperture 7 when the container is in a generally upright orientation. The flow deflector arrangement 500, 600 is further configured to allow the liquid to approach the drinking aperture 7 sideways or indirectly so that the liquid loses much of its energy/momentum by the time it reaches the drinking aperture 7, thereby reducing the possibility and intensity of unexpected spills or splashes when drinking or pouring from the container.

The flow deflector arrangement comprises a portion arranged substantially in front of the drinking aperture 7 to deflect splashing liquid or to prevent it from flowing directly into the drinking aperture 7. In the examples of FIGS. 4 to 17, the reinforcing member in the form of shield panel 550, 650 described above is adapted to serve as the respective flow deflector arrangement 500, 600. For this purpose, the shield panel comprises one or more openings in the proximity of the drinking aperture 7 so as to define a flow opening 21 together with the inner side 3 of the rimless lid 97, 99 cover member. The openings may in the form of one or more cut-outs 551 at the peripheral edge of the shield panel as shown by way of example in FIG. 4, or one or more apertures 551A provided in the shield panel as shown by way of example in FIG. 8A. During drinking, when the container is tilted, liquid flows through the openings, for example between the cut out(s) 551 and the wall of the container, or through the aperture(s) 551A in the shield panel 550, 650, into the flow opening 21 and towards the drinking aperture 7. When the user tilts the container in order to sip the liquid, the liquid first encounters the flow deflector 500, 600 and then approaches the drinking aperture 7 through the flow opening 21. In this manner, the liquid loses much of its energy/momentum by first encountering the flow deflector, i.e. shield panel 500, 600 thereby providing for smoother flow through the drinking aperture 7 during sipping. When the container is in the upright position, the shield panel reinforcing member 550, 650 prevents splashes from reaching the drinking aperture 7.

As described above, the shield panel reinforcing member 550, 650 is connected to the inner side 3 of the cover member of lid 97, 99 by the ribs 530, 540, 630, 640. The ribs 530, 540, 630, 640 act as connectors, connecting the lid 97, 99 cover member and the shield panel 550, 650 as well as spacers to keep the shield panel 550, 650 spaced from the inner side 3 of the cover member.

In the example of FIGS. 4 to 7, a second rib 540 is formed as part of the shield panel 550. The shield panel 550, like the cover member, may be formed from a piece of planar sheet material and folded along pre-defined lines to form the second rib 540. On assembly, the rib 530 of the lid 97 cover member and the rib 540 of the shield panel 550 inter-engage via the slots 535, 545 so as to cross each other and couple the cover member and the shield panel 550.

As described above, in the examples of FIGS. 8 to 17, the reinforcing ribs 630, 640 are movable between expanded and collapsed states. In the expanded state, the reinforcing ribs 630 keep the cover member and the shield panel 650 spaced from each other, so that the lid 99 can be used to close the container (see FIGS. 8, 9). When the reinforcing ribs 630, 640 collapse (see FIGS. 14, 15), the cover member of the lid 99 and the shield panel 650 are moved together so as to reduce or eliminate the space between the cover member and the shield panel 650. Such an arrangement allows a plurality of rimless lids 99 to be stacked and stored whilst minimising storage space required to store the rimless lids 99. The rib 630 is attached to or formed with each of the cover member and the shield panel 650. The rib 640 is attached to or formed with the cover member and releasably attached to the shield panel 650 by a suitable fastening arrangement. The fastening arrangement prevents the ribs 630, 640 from collapsing. In the example of FIGS. 8 to 17, the fastening arrangement comprises a tab 660 provided on the rib 640 and a slot 661 formed in the shield panel 650. As shown in FIGS. 8 to 17, in the expanded state of the reinforcing members/ribs 630, 640, the tab 660 is engaged in the slot 661 and the rib 640 is prevented from articulating relative to the lid 99. The rib 630 has a pair of first hinge lines 675, one close to the lid 99 and the other close to the shield panel 650. The rib 640 has a hinge 677 line close to the lid 99. When the ribs 630, 640 are moved from the expanded state into the collapsed state, for example, by the user applying external force on the lid 99 and the shield panel 650 so as to push the cover member of lid 99 and the shield panel 650 towards each other, tab 660 disengages from the slot 661 and the rib 640 disengages from the shield panel 650. At the same time, the rib 630 is allowed to articulate about the hinge lines 675 relative to the lid 99 and the shield panel 650 and the rib 640 is allowed to articulate about the hinge line 677 relative to the lid 99. As both ribs 630, 640 articulate about their respective hinge lines 675, 677, the cover member and the shield panel 650 move close together and the space between the lid 99 and the shield panel 650 is reduced or eliminated. In order to return the ribs 630, 640 into the expanded state, the user applies a force to the cover member and the shield panel 650 directed to spreading the cover member and the shield panel 650 apart and the above described steps are repeated in reverse order. At the end of the return of the rib 640 into the expanded state, the tab 660 engages the slot 661 and the rib 640 engages the shield panel 650 so as to secure the rib 640 and the entire assembly in the expanded state.

In the examples shown in FIGS. 18, 19 and 20 whereby the reinforcing members do not cross over each other but are non-intersecting, for example substantially or partly parallel 710, 720 as shown by way of example in FIG. 29, or of a ‘Z’ type configuration 700 as shown by way of example in FIG. 28, an arrangement may be provided to maintain the reinforcing members in an expanded state may comprise a movable tab or flap arrangement whereby tab/flap formations 800, optionally extension formations, provided at one or both ends of a reinforcing member are movable from a closed position (FIG. 19) to an open position (FIG. 20) to create an approximately 90 degree angle along a section of a reinforcing member, preferably on each reinforcing member, that wedges between the inner side 3 of the cover member and the shield panel to prevents the respective reinforcing members collapsing and the cover member and shield panel moving closer together and folding back into the collapsed/folded/flat-pack position as shown in FIG. 18. It will be understood that a moveable tab can be positioned elsewhere along a reinforcing member rather than at the end.

Once a moveable tab or flap formation is pushed into the open, fixed position between the cover member and the shield panel, unwanted reverse movement may be prevented by a suitable detent formation, for example a raised line or crease 801 at the preferred retaining position on the cover member and/or on the shield panel, that is configured to catch the flap 800 and hinder it from moving out of engagement between the cover member and shield panel.

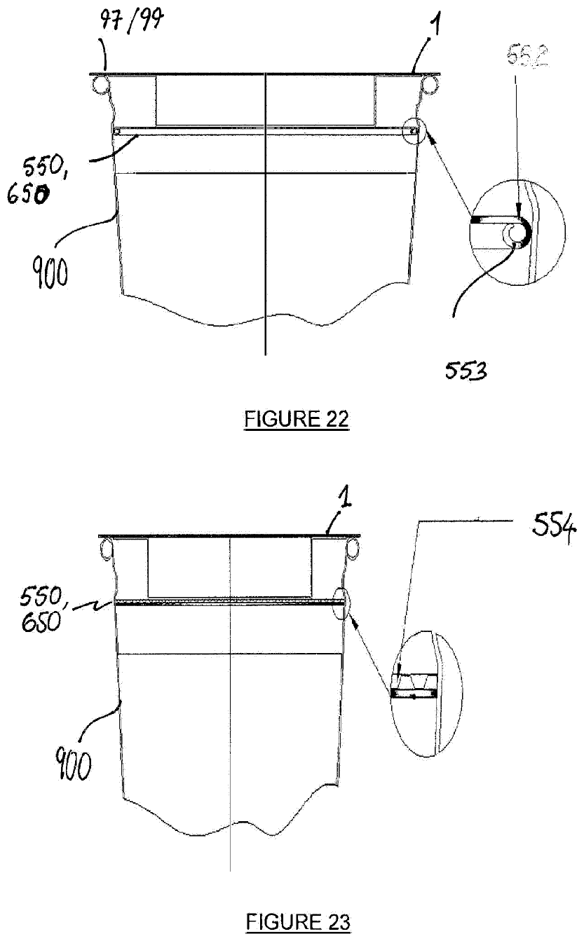

As shown in FIG. 22, the peripheral edge 552 of a shield panel reinforcing member 550, 650 may be curled 553 in order to increase the rigidity of the shield panel.

As shown in FIG. 23, a shield panel reinforcing member 550, 650 may be provided with a supplementary layer 554 in order to increase the rigidity of the shield panel. The supplementary layer may comprise any suitable material or structure.

As shown in FIG. 24, the rimless lid structure in accordance with the invention is capable of fitting substantially inside a container with the lid cover member 99 being substantially level with the rim 901 of the container 900 when the lid is mounted thereto. The rimless lid structure securely attaches to the container by the frictional engagement of the cover member and/or reinforcing member or members with the inner wall of the container. This eliminates the requirement for a curved rim or upstanding and/or depending skirt around the peripheral edge 5 of the lid for clips or fitting over the opening/rim of the container. For aesthetic and hygiene reasons the outer side 1 of the lid cover member may project or span across the top of the opening of the container as shown in FIGS. 21, 22, 23, 24, 26 and 27. As shown in FIG. 25, the peripheral edge 5 of the cover member may locate substantially within the rim of a container proximate the upper edge of said container rim.

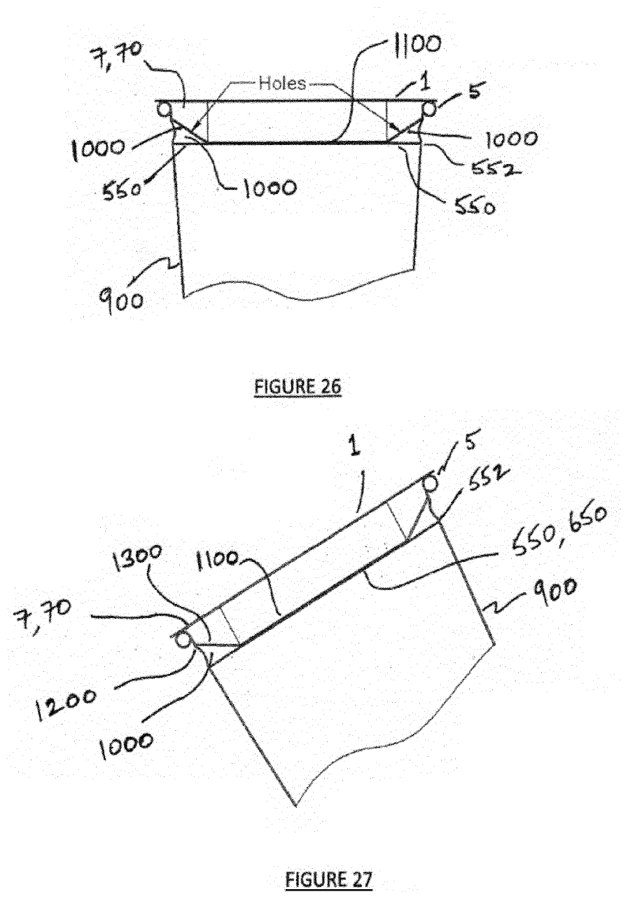

With reference to FIGS. 26 and 26, in examples of the rimless lid, an intermediate well 1000 that acts as a flow deflector to prevent direct splashing out of the container 900, may be created between the shield panel 550, 650 and a second panel 1100 that is provided its flat against and above the reinforcing panel 550, 650 before the rimless lid is fitted into a container. The second panel 1100 is shaped to overlay the reinforcing panel 550, 560 in the area directly below the drinking aperture 7, 70 and is not fixed or glued to the reinforcing panel at this location. The peripheral edge 1200 of the second panel 1100 extends marginally further than the peripheral edge 552 of the reinforcing panel 550, 560. As a consequence, when the rimless lid is fitted into the container 900, the contact created with the inner wall of the container causes the second panel 1100 to separate from the reinforcing panel 550, 650 and create an intermediate well 1000 or substantially enclosed space. One or more cut-outs in the reinforcing panel 550, 650 will allow liquid to flow from the container 900 into the intermediate well 1000 when the container is tilted as shown in FIG. 27. One or more cut-outs 1300 in the second panel 1100 will allow liquid to flow out of the intermediate well 1000 for drinking when the container 900 is tilted. The respective cut-out or cut-outs in the reinforcing panel 550, 560 and the second panel 1100 are located distant and not opposite each other, i.e. staggered, so that liquid cannot splash directly into, through and out of the intermediate well 1000 in a direct line of movement. This arrangement facilitates drinking or pouring from the container 900 in a smooth movement and flow of liquid, but prevents splashing.

Whilst specific examples of the present invention have been described above, it will be appreciated that modifications are possible within the scope of the present invention as defined in the appended claims.

1-38. (canceled)

39. A rimless lid for a container, the rimless lid comprising:
a cover member having an outer side and an inner side and a peripheral edge; and
a reinforcing arrangement comprising one or more reinforcing members located at the inner side of the cover member,
wherein one or more reinforcing members is/are configured to frictionally engage an internal wall of the container when the lid is mounted thereto.

40. A rimless lid as claimed in claim 1, wherein the peripheral edge of the cover member and at least one reinforcing member are configured to frictionally engage an internal wall of the container;
optionally, wherein the or each reinforcing member makes frictional contact with the inner wall of the container at at least two discrete locations on the inner wall of the container.

41. A rimless lid as claimed in claim 1, wherein there is provided a reinforcing member comprising a reinforcing panel that is connected to the one or more reinforcing members located at the inner side of the cover member, the reinforcing panel comprising a peripheral edge that is configured to frictionally engage the internal wall of the container and being arranged spaced apart from and substantially parallel with said cover member.

42. A rimless lid as claimed in claim 39, wherein the one or more reinforcing members are arranged so as to fit snugly against and/or deform the wall of the container in use thereby holding the rimless lid securely in place, imparting rigidity on the rimless lid/container assembly and providing structural support and rigidity to the rimless lid.

43. A rimless lid as claimed in claim 39, wherein at least one reinforcing member located at the inner side of the cover member extends across the inner side of said cover member;
optionally, wherein the at least one reinforcing member located at the inner side of the cover member has a pair of opposite container engaging portions located at opposite peripheral locations on the inner side of the lid, such that when the lid is placed over an open top of the container in use, said at least one reinforcing member enters the container and the container engaging portions frictionally engage the internal wall of the container, whereby the lid is secured to the container.

44. A rimless lid as claimed in claim 43, wherein at least two reinforcing members located at the inner side of the cover member are provided, each reinforcing member being provided across the inner side of the lid;
optionally, wherein the at least two reinforcing members cross each other;
optionally, wherein suitable cooperating slots or other openings are made in the reinforcing members so that the reinforcing members can cross each other upon assembly.

45. A rimless lid as claimed in claim 39, wherein the one or more reinforcing members are movable between expanded and collapsed states, wherein in the expanded state, the one or more reinforcing members project proud of the inner side of the cover member so the rimless lid can be used to close the container and in the collapsed state the one or more reinforcing members are positioned closer to the rimless lid, optionally, flush with the rimless lid.

46. A rimless lid as claimed in claim 45, wherein the one or more reinforcing members comprise a first rib and a second rib crossing each other, wherein cooperating openings are configured in the first and second ribs so that the first and second ribs cross each other upon assembly and to permit movement of the first and second ribs relative to each other and articulation relative to the rimless lid during movement between the expanded and collapsed states.

47. A rimless lid as claimed in claim 46, wherein each of the first rib and the second rib has fold or hinge lines adjacent the lid;
optionally, wherein when the first and second ribs are moved from the expanded state into the collapsed state the first and second ribs are allowed to articulate about their respective hinge lines relative to the rimless lid and thereby move closer to the cover member and in order to bring the first and second ribs into the expanded state, the first and second ribs are pivoted in the opposite direction, away from the cover member, about their respective hinge lines until the first and second ribs project proud of the inner side of the cover member.

48. A rimless lid as claimed in claim 45, further comprising a fastening arrangement to secure the reinforcing member(s) in the expanded state.

49. A rimless lid as claimed in claim 48, wherein the fastening arrangement to maintain the reinforcing member(s) in the expanded state comprises one or more movable tab or flap formations provided on one or more reinforcing members, the tabs or flap formations being movable from a closed position to an open position thereby wedging between the inner side of the cover member and the shield panel;
optionally, wherein the fastening arrangement to maintain the reinforcing member(s) in the expanded state comprises a means to prevent reverse movement of a tab or flap formation from an open position to a closed position, the means comprising a detent formation at a defined retaining position on the cover member and/or on the shield panel, the detent being configured to engage the flap to hinder it from moving out of engagement between the cover member and shield panel.

50. A rimless lid as claimed in claim 39, wherein a drinking aperture is formed in the cover member;
optionally, wherein the drinking aperture is defined by a segment having a curved or arced chord that is cut or otherwise removed from the peripheral edge of the rimless lid cover member.

51. A rimless lid as claimed in claim 39, wherein the rimless lid has a shape different from the shape of the rim of the container.

52. A rimless lid as claimed in claim 50 further comprising a flow deflector arrangement adjacent to the drinking aperture, wherein the flow deflector arrangement is configured to prevent liquid contained in the beverage container from splashing directly upwardly through the drinking aperture when the beverage container is in a generally upright orientation.

53. A rimless lid as claimed in claim 50, wherein the rimless lid comprises a first flap formed in the rimless lid and initially blocking the drinking aperture;
optionally, wherein the first flap is movable between open and closed positions, wherein in the closed position, the first flap is positioned across the drinking aperture and in the open position the flap is positioned perpendicular to or at an angle in relation of the plane of the drinking aperture;
optionally, wherein the flow deflector arrangement is independent from the first flap.

54. A rimless lid as claimed in claim 52, wherein the flow deflector arrangement comprises a portion arranged substantially in front of the drinking aperture to deflect splashing liquid or to prevent it from flowing directly into the drinking aperture.

55. A rimless lid as claimed in claim 54, wherein the flow deflector arrangement is arranged on the inner side of the cover member so as, together with the inner side of the cover member, to define a flow opening facing sideways relative to the inner side of the rimless lid, towards a wall of the beverage container when the rimless lid is in use.

56. A rimless lid as claimed in claim 53, wherein the flow deflector arrangement comprises a panel provided on the inner side of the cover member underneath the first flap or on the outer side of the cover member over the first flap, the panel having a second flap formed in the panel and the second flap being movable between open and closed positions, wherein in the closed position, the second flap is oriented across the drinking aperture and in the open position the second flap is positioned perpendicular to or at an angle in relation of the plane of the drinking aperture;
optionally, wherein the first and second flaps are superimposed so that when the upper one of the first and second flaps is pushed through the drinking aperture, the lower one of the first and second flaps is also pushed by the upper flap into the open position, wherein when both the first and the second flaps have been pushed downwardly into the open position, the first and second flaps remain engaged and, thereby form a shield adjacent to the drinking aperture and, simultaneously, together with the inner side of the cover member, define the flow opening.

57. A rimless lid as claimed in claim 52, wherein the flow deflector arrangement comprises a permanent shield of suitable shape and size formed on the inner side of the cover member.

58. A rimless lid as claimed in claim 50, wherein the peripheral edge, of the cover member and at least one reinforcing member are configured to frictionally engage an internal wall of the container;
optionally, wherein the or each reinforcing member makes frictional contact with the inner wall of the container at at least two discrete locations on the inner wall of the container further comprising a second panel provided against and above the reinforcing panel, the second panel being shaped to overlay the reinforcing panel in the area directly below the drinking aperture, wherein a peripheral edge of the second panel extends further than the peripheral edge of the shield panel so that when the rimless lid is fitted to a container, contact created with the inner wall of the container causes the second panel to separate from the reinforcing panel to create an intermediate well intermediate the reinforcing panel and the second panel.
